(19) United States
(12) Patent Application Publication
(10) Pub. No.: US 2012/0155371 A1
(43) Pub. Date: Jun. 21, 2012

(54) METHOD FOR ACCESSING WIRELESS DISTRIBUTION SYSTEM, SYSTEM AND WIRELESS REPEATER THEREOF

(76) Inventor: Zhanli Wang, Shenzhen (CN)

(21) Appl. No.: 13/259,086

(22) PCT Filed: Dec. 22, 2009
(86) PCT No.: PCT/CN2009/075839

§ 371 Date: Jan. 26, 2012

(30) Foreign Application Priority Data
Sep. 1, 2009 (CN) 200910171632.3

(51) Int. Cl. H04W 40/00; H04B 7/14

(52) U.S. Cl. 370/315

(57) ABSTRACT

The present invention discloses a method and a system for accessing a wireless distribution system, and a wireless repeater. The wireless repeater (100) comprises: a dialing module (110), configured to acquire an IP address for the wireless repeater; and a routing and forwarding module (108), configured to forward the data transmitted between the Internet and a user device using the IP address. The present invention is capable of conveniently increasing accessible users.

### FIELD OF THE INVENTION

The present invention relates to the communication field, and in particular to a method and a system for accessing a wireless distribution system (WDS), and a wireless repeater.

### BACKGROUND OF THE INVENTION

Wireless local area network has been widely used as an access technology for network terminals, because of its advantages of high access speed, simple wiring, etc. There can be some complicated service situations. For example, a user uses a wireless router on a two-story house and the router is placed on the first floor, which causes the signal in some rooms upstairs to be weakened; and for another example, a user wishes to share broadband with his neighbor in the next door but the obstacles between them make the wiring inconvenient and the laptop accessing the neighbor's wireless network is frequently disconnected. In such complicated situations, two WDS-supporting wireless repeat devices can be used to extend wireless network coverage and solve the network use problem.

In general, one of the two above mentioned WDS-supporting wireless devices is referred to as a wireless access point, or simply referred to as AP, while the other is referred to as a wireless repeater, or simply referred to as Repeater. The wireless access point accesses the Internet through the broadband access technologies (such as xDSL, xPON, 3G and other broadband access technologies) which it supports. The wireless repeater performs wireless relay to the wireless access point via the WDS, and forwards a message of a wireless repeater user accessing the Internet to the wireless access point through bridging via a WDS wireless interface, and the wireless access point sends this user message to the Internet. Then, the wireless access point further forwards a message responded from the Internet to the wireless repeater via the WDS wireless interface, and the wireless repeater further sends this message to this user through bridging.

In the systems for accessing a WDS in relevant art, the wireless repeater is only used for forwarding messages between a wireless access point AP and a user, while the AP serves to assign the routes. Since the assignable routing addresses of the AP are limited, the total number of users who can access a plurality of wireless repeaters is limited to the number of assignable routing addresses of the AP. Thus, when the number of accessing users increases, more APs will be needed, which would be difficult to configure since the APs are located at the system network side.

### SUMMARY OF THE INVENTION

The object of the present invention is to provide a method and a system for accessing a wireless distribution system and a wireless repeater, which is capable of solving the technical problem in relevant art that when the number of accessing users increases, more APs need to be added, and it is difficult to configure these APs.

A wireless repeater for a wireless distribution system is provided according to one aspect of the present invention, comprising: a dialing module, configured to acquire an IP address for the wireless repeater; and a routing and forwarding module, configured to use the IP address to forward the data transmitted between the Internet and a user equipment.

Preferably, the dialing module comprises: a sending unit, configured to send a request to the Internet, with the request carrying the identification of the wireless repeater; a receiving unit, configured to receive an allocated IP address; and a configuring unit, configured to set the received IP address as an IP address of the wireless repeater.

Preferably, the wireless repeater further comprises: a wireless distribution system interface module, configured to perform wireless relay to a wireless access point of the wireless distribution system; and a user interface module, configured to access the user equipment.

Preferably, said data comprises unicast data, multicast data and broadcast data.

Preferably, said data is unicast data, and said routing and forwarding module forwards the data transmitted between the Internet and the user equipment according to said IP address.

A system for accessing a wireless distribution system is further provided according to another aspect of the present invention, comprising: a wireless access point and a wireless repeater, wherein the wireless repeater comprising: a dialing module, configured to acquire an IP address for the wireless repeater; and a routing and forwarding module, configured to use the IP address to forward the data transmitted between the Internet and a user equipment.

Preferably, the dialing module comprises: a sending unit, configured to send a request to the Internet, with the request carrying the identification of the wireless repeater; a receiving unit, configured to receive an allocated IP address; and a configuring unit, configured to set the received IP address as an IP address of the wireless repeater.

Preferably, the wireless repeater further comprises: a wireless distribution system interface module, configured to perform wireless relay to a wireless access point of the wireless distribution system; and a user interface module, configured to access the user equipment.

Preferably, the wireless access point comprises: a forwarding module, configured to forward the data transmitted between the Internet and the wireless repeater.

Preferably, said data comprises unicast data, multicast data and broadcast data.

Preferably, said data is unicast data, and said routing and forwarding module forwards the data transmitted between the Internet and the user equipment according to said IP address.

A method for accessing a wireless distribution system is also provided according to another aspect of the present invention, comprising: acquiring an IP address for a wireless repeater; and accessing the wireless repeater into the Internet via a wireless access point according to the IP address.

Preferably, acquiring an IP address for a wireless repeater in particular comprises: the wireless repeater acquiring an IP address for Internet access by manner of PPPoE or IPoE dialing.

Preferably, the wireless repeater accessing the Internet via a wireless access point according to the IP address in particular comprises: establishing wireless relay between the wireless repeater and the wireless access point; connecting the wireless access point into the Internet; user equipment sending an Internet access message to the wireless repeater, the wireless repeater routing and forwarding this message to the wireless access point; the wireless access point sending the message to the Internet; the Internet returning a corresponding response message according to the message and sending the response message to the wireless access point; the wireless access point sending the response message to the wireless repeater; and the wireless repeater routing and forwarding the response message to the user equipment.

Through at least one of the above technical solutions, the wireless repeater is provided with routing and forwarding function by acquiring an IP address for the wireless repeater with a dialing module. Thus the number of users accessible to the system can be increased by adding wireless repeaters at user side without adding any APs when the number of the users accessing the system is relatively large. Therefore the present invention avoids the technical problem that when the number of accessing users increases, more APs need to be added and it is difficult to configure these APs, and achieves the technical effect of being able to conveniently increase accessible users.

### BRIEF DESCRIPTION OF THE DRAWINGS

The drawings herein are used to provide a further understanding of the present invention and form a part of the specification. The drawings are used to explain the present invention together with the embodiments of the present invention, and do not constitute undue limitation on the scope of the present invention. In the drawings:

FIG. 1 is a block diagram of a wireless repeater according to the first embodiment of the present invention;

FIG. 2 is a block diagram of a system for accessing a wireless distribution system according to the second embodiment of the present invention;

FIG. 3 is a flow chart of a method for accessing a wireless distribution system according to the third embodiment of the present invention; and

FIG. 4 is a flow chart of a method for accessing a wireless distribution system according to the fourth embodiment of the present invention.

### DETAILED DESCRIPTION OF THE EMBODIMENTS

The preferred embodiments of the invention will be described in conjunction with the drawings, and it shall be understood that the preferred embodiments described hereinafter are only to illustrate, and not to limit the present invention.

For the purpose of explanation, several specific details are described in the description below to offer a thorough understanding of the present invention. However, it is apparent that the present invention can be implemented even without these specific details. Additionally, the following embodiments and the details of these embodiments can be combined variously if there is no conflict, i.e. without departing from the spirit and scope interpreted by the appended claims.

### First Embodiment

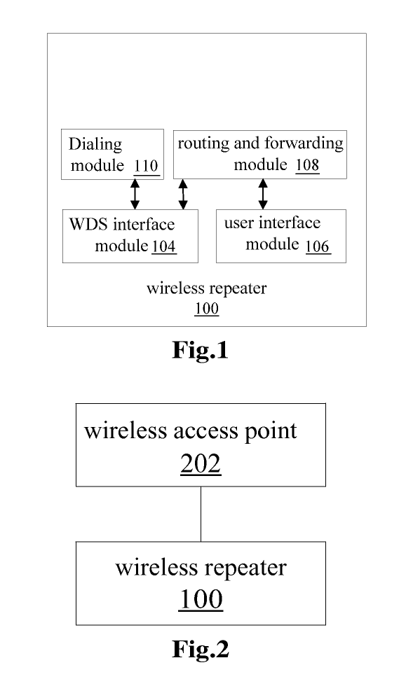

FIG. 1 is a block diagram of a wireless repeater according to the first embodiment of the present invention.

As shown in FIG. 1, a wireless repeater 100 according to the first embodiment of the present invention comprises: a dialing module 110, configured to acquire an IP address for the wireless repeater; and a routing and forwarding module 108, configured to use the IP address to forward the data transmitted between the Internet and a user equipment.

The wireless repeater according to the first embodiment of the present invention acquires a routing address for the wireless repeater with the dialing module. It can increase the number of users accessible to the system by adding wireless repeaters at user side without needing to add any APs when the number of the users accessing the system is relatively large. Thus, it avoids the technical problem that when the number of accessing users increases, more APs need to be added and it is difficult to configure these APs, and achieves the technical effect of being able to conveniently increase accessible users.

For example, in relevant art, the number of distributable routing addresses for an AP is 255. Thus the maximum number of the users who access this AP via N wireless repeaters is 255. While the maximum number of the users who access this AP via N wireless repeaters in the system for accessing a wireless distribution system according to the first embodiment of the present invention will be N*255. Moreover, when the number of users increases, it only needs to increase the number of wireless repeaters to achieve the object of increasing accessing users.

Additionally, the wireless repeater according to the first embodiment of the present invention reduces the functional requirements for the wireless access point by the users who access via the wireless repeater. When the users access the Internet by using routing mode, since the routing mode has already been achieved on the wireless repeater, it is no longer necessary for the wireless access point to provide access by manner of routing, which makes the networking and application more flexible.

Additionally, the wireless repeater according to the first embodiment of the present invention can further simplify the functional requirements and interface requirements for the wireless access point and wireless repeater, thus achieving the object of reducing the costs. The wireless access point provides broadband access technologies (such as xDSL, xPON, 3G and other access technologies) in the uplink, and provides WDS wireless relay and user access in the downlink, and bridges and forwards a message of a user accessing the Internet. The wireless repeater only provides WDS wireless relay in the uplink and provides user access in the downlink and bridges or routes and forwards a message from a user. That is to say, the AP in the system for accessing a wireless distribution system according to the first embodiment of the present invention only needs to implement the functions of data forwarding and protocol conversion; thus achieves the technical effects of simplifying the form of devices and reducing the total costs.

Preferably, the dialing module comprises: a sending unit, configured to send a request to the Internet, with the request carrying the identification of the wireless repeater; a receiving unit, configured to receive an allocated IP address; and a configuring unit, configured to set the received IP address as an IP address of the wireless repeater.

The wireless repeater supports a routing module and a dialing module (such as PPPoE, IPoE and other dialing modules) thereon. After the WDS connection between a wireless repeater and a wireless access point device is successful, the wireless repeater initiates a dialing to acquire an IP address for accessing the Internet through a WDS wireless interface and via the wireless access point device. A message of a wireless repeater user is forwarded by the routing module of the wireless repeater, sent to the wireless access point device through the WDS wireless interface, and then to the Internet.

Preferably, the wireless repeater further comprises: a WDS interface module 104, configured to perform wireless relay to a wireless access point of the wireless distribution system; and a user interface module 106, configured to access the user equipment.

The WDS interface module is configured to carry out the WDS wireless relay to the wireless access point, wherein a message from the wireless repeater is sent to the wireless access point via the WDS interface, while a message from the wireless access point is sent to the wireless repeater via the WDS interface. The user interface module is configured to carry out the access of a wireless repeater user, in which the user carries out the sending/receiving of the messages to/from the wireless repeater via the user interface module. This is to achieve the object of allowing the user to access the Internet by using a wireless repeater.

Preferably, said data comprises unicast data, multicast data and broadcast data.

Preferably, said data is unicast data, and said routing and forwarding module forwards the data transmitted between the Internet and the user equipment according to said IP address.

As the multicast and broadcast IP messages are sent in group, they can be received by a repeater even if the repeater has not acquired a public network IP for accessing the Internet. The routing and forwarding of unicast data is limited by whether the repeater has acquired an external network IP address, while multicast and broadcast are not. Thus, only after the repeater has acquired an IP address for accessing the external network, all kinds of messages (unicast, multicast, broadcast) can be transmitted between the Internet and the user as well as between the Internet and the repeater via the routing and forwarding module.

The wireless repeater according to the first embodiment of the present invention avoids the technical problem that when the number of accessing users increases, more APs need to be added and it is difficult to configure these APs. Thus, it can achieve the technical effect of being able to conveniently increase accessible users.

### Second Embodiment

FIG. 2 is a block diagram of a system for accessing a wireless distribution system according to the second embodiment of the present invention.

As shown in FIG. 2, the system for accessing a wireless distribution system according to the second embodiment of the present invention comprises: a wireless access point 202 and a wireless repeater 100, wherein the wireless repeater 100 comprises: a dialing module, configured to acquire an IP address for the wireless repeater; and a routing and forwarding module, configured to us the IP address to forward the data transmitted between the Internet and a user equipment.

By allocating an IP address for the wireless repeater, the system for accessing a wireless distribution system according to the second embodiment of the present invention makes it possible to increase the number of users accessible to the system by adding wireless repeaters at user side without adding any APs when the user number of the access system is relatively large. Thus it avoids the technical problem that when the number of accessing users increases more APs need to be added and it is difficult to configure these APs, and achieves the technical effect of being able to conveniently increase accessible users.

Preferably, the dialing module comprises: a sending unit, configured to send a request to the Internet, with the request carrying the identification of the wireless repeater; a receiving unit, configured to receive an allocated IP address; and a configuring unit, configured to set the received IP address as an IP address of the wireless repeater.

The wireless repeater supports a routing module and a dialing module (such as PPPoE, IPoE and other dialing modules) thereon. After the WDS connection between a wireless repeater and a wireless access point device is successful, the wireless repeater initiates a dialing to acquire an IP address for accessing the Internet via a WDS wireless interface and the wireless access point device. The message from a wireless repeater user is forwarded by the routing module of the wireless repeater, sent to the wireless access point device through the WDS wireless interface, and then to the Internet.

Preferably, the wireless repeater further comprises: a wireless distribution system interface module, configured to perform wireless relay to a wireless access point of the wireless distribution system; and a user interface module, configured to access a user equipment.

The WDS interface module is configured to carry out the WDS wireless relay to the wireless access point. Messages from the wireless repeater are sent to the wireless access point via the WDS interface while messages from the wireless access point are sent to the wireless repeater via the WDS interface. The user interface module is configured to carry out the access of a wireless repeater user, and the user carries out the sending/receiving of the messages to/from the wireless repeater via the user interface module. This is to achieve the object of allowing a user equipment to access the Internet by using a wireless repeater.

Preferably, the wireless access point comprises: a forwarding module, configured to forward the data transmitted between the Internet and the wireless repeater.

Preferably, said data comprises unicast data, multicast data and broadcast data.

Preferably, said data is unicast data, and said routing and forwarding module forwards the data transmitted between the Internet and the user equipment according to said IP address.

As the multicast or broadcast IP messages are sent in group, they can be received by the repeater even if the repeater has not acquired a public network IP for accessing the Internet. The routing and forwarding of unicast data is limited by whether the repeater has acquired an external network IP address, while multicast and broadcast are not. Thus, only after the repeater has acquired an IP address for accessing the external network, all kinds of messages (unicast, multicast, broadcast) can be transmitted between the Internet and the user as well as between the Internet and the repeater via the routing and forwarding module.

The system for accessing a wireless distribution system according to the second embodiment of the present invention avoids the technical problem that when the number of accessing users increases more APs need to be added and it is difficult to configure these APs, and thus achieves the technical effect of being able to conveniently increase accessible users.

### Third Embodiment

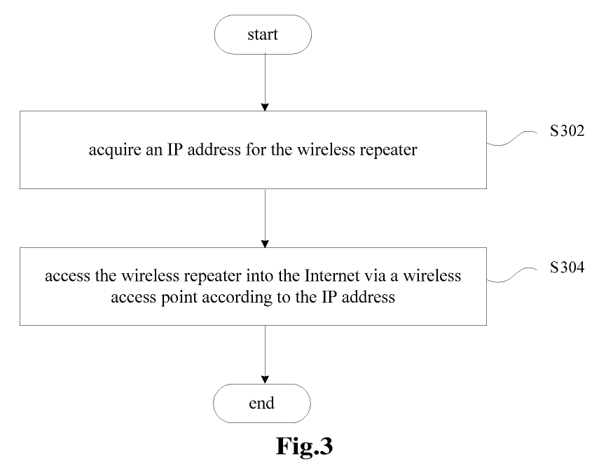

FIG. 3 is a flow chart of a method for accessing a wireless distribution system according to the third embodiment of the present invention. This method can be achieved by the above system for accessing a wireless distribution system and the above wireless repeater. As shown in FIG. 3, the method for accessing a wireless distribution system according to the third embodiment of the present invention comprises:

Step S302: Acquire an IP address for the wireless repeater; and the wireless repeater is able to acquire an IP address for Internet access by the dialing manners of PPPoE, IPoE, etc.;

Step S304: Access the wireless repeater into the Internet via a wireless access point according to the IP address; establish wireless relay between the wireless repeater and the wireless access point; connect the wireless access point into the Internet; user equipment sends a message for Internet access to the wireless repeater, and the wireless repeater routes and forwards this message to the wireless access point; the wireless access point sends this message to the Internet; the Internet returns a corresponding response message according to this message and sends the response message to the wireless access point; the wireless access point sends the response message to the wireless repeater; and the wireless repeater routes and forwards the response message to the user equipment.

By allocating a routing address for the wireless repeater, the method for accessing a wireless distribution system according to the third embodiment of the present invention makes it possible to increase the number of users accessible to the system by adding wireless repeaters at user side without needing to add any APs when the number of the users accessing system is relatively large. Thus it avoids the technical problem that when the number of accessing users increases, more APs need to be added and it is difficult to configure these APs, and achieves the technical effect of being able to conveniently increase accessible users.

The method for accessing a wireless distribution system according to the third embodiment of the present invention avoids the technical problem that when the number of accessing users increases more APs need to be added and it is difficult for configuring, thus achieving the technical effect of being able to conveniently increase accessible users.

### Fourth Embodiment

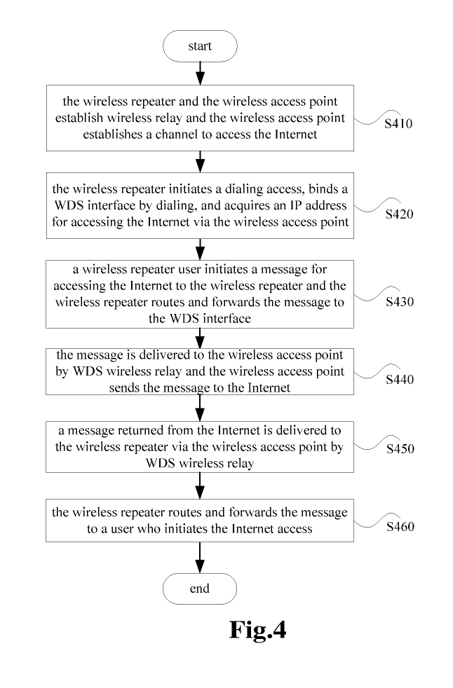

FIG. 4 is a flow chart of a method for accessing a wireless distribution system according to the fourth embodiment of the present invention. As shown in FIG. 4, the method for accessing a wireless distribution system according to the fourth embodiment of the present invention comprises:

Step S410: Establish WDS wireless relay between the wireless repeater and the wireless access point, and the wireless access point establishes a channel for Internet access;

Step S420: The wireless repeater initiates a dialing access, binds a WDS interface by dialing, and acquires an IP address for Internet access via the wireless access point;

Step S430: The message for Internet access initiated by the wireless repeater user arrives at the wireless repeater, and the wireless repeater forwards the message to the WDS interface;

Step S440: The message is delivered to the wireless access point by WDS wireless relay, and the wireless access point sends the message to the Internet;

Step S450: A message returned from the Internet is delivered to the wireless repeater via the wireless access point by WDS wireless relay; and

Step S460: The wireless repeater routes and forwards the message and sends it to a user who initiates this Internet access.

The method for accessing a wireless distribution system according to the fourth embodiment of the present invention avoids the technical problem that when the number of accessing users increases more APs need to be added and it is difficult to configure these APs, and thus achieves the technical effect of being able to conveniently increase accessible users.

In summary, the method and system for accessing a wireless distribution system as well as the wireless distribution system according to the embodiments of the present invention avoid the technical problem that when the number of accessing users increases more APs need to be added and it is difficult to configure, and thus achieves the technical effect of being able to conveniently increase accessible users.

Apparently, those skilled in the art should understand that the above-mentioned modules and steps of the present invention can be realized by using general purpose calculating device, can be integrated in one calculating device or distributed on a network which consists of a plurality of calculating devices, and alternatively can be realized by using the executable program code of the calculating device, so that consequently they can be stored in the storing device and executed by the calculating device; or they can be made into integrated circuit module respectively, or a plurality of modules or steps thereof are made into one integrated circuit module. In this sense, the present invention is not restricted to any particular hardware and software combination.

Above description is only to illustrate the preferred embodiments but not to limit the present invention. Any amendments, equivalent substitutions, improvements etc. within the basic idea and principle of the present invention are all included in the scope of the present invention.

1. A wireless repeater for a wireless distribution system, comprising:
a dialing module, configured to acquire an IP address for said wireless repeater; and
a routing and forwarding module, configured to use said IP address to forward the data transmitted between the Internet and a user equipment.

2. The wireless repeater according to claim 1, wherein said dialing module comprises:
a sending unit, configured to send a request to the Internet, with the request carrying the identification of said wireless repeater;
a receiving unit, configured to receive an allocated IP address; and
a configuring unit, configured to set said received IP address as an IP address of said wireless repeater.

3. The wireless repeater according to claim 1, wherein further comprises:
a wireless distribution system interface module, configured to perform wireless relay to a wireless access point of the wireless distribution system; and
a user interface module, configured to access said user equipment.

4. The wireless repeater according to claim 1, wherein said data comprises unicast data, multicast data, and broadcast data.

5. The wireless repeater according to claim 4, wherein said data is unicast data and said routing and forwarding module forwards the data transmitted between the Internet and the user equipment according to said IP address.

6. A system comprising a wireless access point and a wireless repeater for accessing a wireless distribution system, said wireless repeater comprises:
a dialing module, configured to acquire an IP address for said wireless repeater; and
a routing and forwarding module, configured to use said IP address to forward the data transmitted between the Internet and the user equipment.

7. The system according to claim 6, wherein said dialing module comprises:
a sending unit, configured to send a request to the Internet, with the request carrying the identification of said wireless repeater;
a receiving unit, configured to receive an allocated IP address; and
a configuring unit, configured to set said received IP address as an IP address of said wireless repeater.

8. The system according to claim 6, wherein said wireless repeater further comprises:
a wireless distribution system interface module, configured to perform wireless relay to a wireless access point of the wireless distribution system; and
a user interface module, configured to access said user equipment.

9. The system according to claim 6, wherein said wireless access point comprises:
a forwarding module, configured to forward the data transmitted between said Internet and said wireless repeater.

10. The system according to claim 6, wherein said data comprises unicast data, multicast data, and broadcast data.

11. The system according to claim 6, wherein said data is unicast data and said routing and forwarding module forwards the data transmitted between the Internet and the user equipment according to said IP address.

12. A method for accessing a wireless distribution system, comprising:
acquiring an IP address for a wireless repeater; and
accessing said wireless repeater into the Internet via the wireless access point according to said IP address.

13. The method according to claim 12, wherein acquiring an IP address for said wireless repeater comprises:
said wireless repeater acquiring the IP address for Internet access by manner of PPPoE or IPoE dialing.

14. The method according to claim 12, wherein accessing said wireless repeater into the Internet via the wireless access point according to said IP address comprises:
establishing wireless relay between said wireless repeater and said wireless access point;
connecting said wireless access point to said Internet;
said user equipment sending a message for Internet access to said wireless repeater, and said wireless repeater routing and forwarding said message to said wireless access point;
said wireless access point sending said message to said Internet;
said Internet returning a corresponding response message according to said message and sending said response message to said wireless access point;
said wireless access point sending said response message to said wireless repeater; and
said wireless repeater routing and forwarding said response message to said user equipment.
